(19) United States
(12) Patent Application Publication
(10) Pub. No.: US 2008/0318714 A1
(43) Pub. Date: Dec. 25, 2008

(54) Transitioning Lacrosse Stick Handle

(75) Inventors: Joanna Kotula, Baltimore, MD (US); Christopher Saturnio, Crofton, MD (US)

Correspondence Address: PAUL, HASTINGS, JANOFSKY & WALKER LLP, 875 15th Street, NW, Washington, DC, 20005, US

(73) Assignee: STX, LLC

(21) Appl. No.: 12/142,178

(22) Filed: Jun. 19, 2008

Related U.S. Application Data
(60) Provisional application No. 60/944,955, filed on Jun. 19, 2007.

(51) Int. Cl. A63B 59/02; B29C 57/00

(52) U.S. Cl. 473/513; 264/530

(57) ABSTRACT

An embodiment of the invention provides a monolithic lacrosse stick handle having a first portion, a second portion, and a transition portion disposed between the first and second portion. The first portion has a first cross-section of a first shape. The second portion has a second cross-section of a second shape. The second shape is different from the first shape. Over the transition portion, the cross-sectional shape of the handle transitions from the first shape to the second shape. The handle can be integrally formed from a malleable material. The handle can have varying cross-sectional areas (e.g., wall thicknesses) along its length.

This application claims the benefit of U.S. Provisional Application No. 60/944,955, filed Jun. 19, 2007, which is herein incorporated by reference in its entirety.

### BACKGROUND

1. Field of the Invention

The present invention relates generally to lacrosse stick handles (also referred to as shafts), and more particularly, to a lacrosse stick handle having a variable cross-section that transitions in shape, size, and/or area over the length of the handle.

2. Background of the Invention

Handling a lacrosse stick requires a player to hold and control a lacrosse stick handle in specific ways, with many different combinations of hand placement over the length of the handle. A lacrosse player constantly moves his hands along the handle in multiple positions.

In executing game skills, lacrosse players must be able to grip and control the lacrosse stick handle. This control is generally referred to as “stick handling.” Effective stick handling requires a player to constantly reposition his hands along the handle to control the head of the lacrosse stick. As used herein, “stick” refers to the apparatus as a whole, including the handle (or shaft) on which a player's hand(s) is/are placed and the head.

For effective stick handling, each hand placement enables the player to impart force and torque on the lacrosse stick to effect a desired motion, e.g., throwing a ball. In addition, in competitive situations, the player must quickly change hand placements and grips to react to and outplay his opponent. Thus, between the execution of consecutive skills, a player must release or slide one of his hands, move it to a new position, and re-grip the handle with a strong hold.

An example of this constant hand repositioning is a lacrosse player who scoops a ground ball, cradles the ball while running, and then throws the ball. In chasing the ground ball, the player typically grabs the lacrosse stick handle at or near its end with one hand (referred to herein as the “lower hand”) and at or near its midpoint with the other hand (referred to herein as the “upper hand”), and extends the lacrosse stick out in front while running or bending down toward the ground. Once the ball is scooped up and in the pocket of the lacrosse stick head, the player pulls the lacrosse stick toward his body and simultaneously repositions one or both hands, often grabbing the handle with the upper hand just under the throat portion of the lacrosse stick head. While running and cradling the ball, the player may release the lower hand from the bottom of the handle and cradle the stick with the upper hand near the throat portion.

Then, when preparing to throw, the player re-grips the bottom end of the handle and cocks the stick back with both hands. In completing the throwing motion, as the player moves his upper hand forward and lower hand back, the upper hand on the throat area slides down the shaft toward the lower hand. Throughout the throwing and follow-through motions, the lower hand tightly grips the shaft near its end to maintain control and accuracy. Thus, in the course of executing three consecutive game skills, the player quickly repositions his hands multiple times.

The ability to quickly reposition hand placement without losing control of the handle requires a player to make subtle adjustments in hand gripping force. A strong gripping force is required to hold and cock the stick, especially for the lower hand. An intermediate gripping force is required to slide a hand along the shaft without releasing the handle entirely. Such rapid grip adjustments are sometimes difficult to execute on conventional handles, which tend to have largely uniform surfaces that do not cooperate with a player's hand. In addition, factoring in the effects of fatigue, perspiration, cold temperatures, and inclement weather, it is easy to see why players often lose a firm grip on lacrosse stick handles.

In addition, the use of protective gloves can further frustrate a player's firm grip on the lacrosse stick shaft. Although these gloves protect the outside of a player's hand, the layer of material between the shaft and the player's palm and fingers, no matter how tacky, reduces the player's feel for the shaft. Additionally, moisture from, for example, inclement weather makes firm gripping difficult.

To improve the grip, players sometimes tape the shafts with athletic tape, Tourna Grip™, or similar grip materials. Although these minor adjustments may approximate a grip, it is difficult to build shapes out of the tape that complement finger placement and/or that increase the diameter of the handle to aid a player in using the required gripping force. The tape can also add undesirable weight to the lacrosse stick. Furthermore, the tape rarely adheres well to the shaft, tends to slide, and does not move in unison with the shaft. Indeed, the tape is extremely susceptible to wearing, tattering, and falling off. Thus, players must constantly remove and replace the tape.

Lacrosse manufacturers have also added grips, overlays, and other materials to lacrosse stick handles to improve grip. One example is disclosed in U.S. Pat. No. 6,500,079 to Tucker, Sr., which is assigned to the assignee of the present invention, and is incorporated by reference herein. Other designs have altered the orientation or cross-sectional shape of a handle, for example, as disclosed in U.S. Pat. No. 5,048,843 to Dorfi et al. and U.S. Published Patent Application No. 20050282667 to Morrow. Contoured lacrosse stick handles made of composite materials formed by wrapping or lay-ups also exist, although such constructions can suffer from problems with durability (e.g., brittleness) and with feel or texture that hinders hand sliding.

### SUMMARY OF THE INVENTION

The present invention provides a lacrosse stick handle having a variable cross-section that transitions in shape, size, and/or area over the length of the handle. The different cross-sections can accommodate lacrosse-specific hand movements, in terms of how and where a player grips the handle and slides his hands while playing lacrosse. In addition, the different cross-sections can provide desired degrees of strength, rigidity, and durability at particular locations along the handle, especially by varying the wall thickness of the handle.

An embodiment of the present invention provides a lacrosse stick handle with at least two cross-sectional shapes. The first shape is an extreme concave octagon, provided throughout a lower portion of the handle, approximately from the middle of the handle to the butt end of the handle. The second shape is a teardrop, provided throughout an upper portion of the handle, approximately from the middle of the handle to proximate the end of the handle that connects to the lacrosse head. The handle transitions between the octagonal shape and the teardrop shape, for example, at about the mid-point of the handle, and can then transition again from the teardrop shape to the octagonal shape proximate to the end of the handle for insertion into a socket of the lacrosse head. The cross-sectional shape, length, and location of the octagonal and teardrop portions of the lacrosse stick handle accommodate the gripping, sliding, and carrying techniques unique to lacrosse.

Another embodiment of the present invention also provides a lacrosse stick handle with at least two cross-sectional shapes. The first shape is an octagon that varies in dimension to provide an overall undulating contour to a lower portion of the handle, approximately from the middle of the handle to the butt end of the handle. The undulating contour accommodates the natural shape of a player's hand or fingers and improves grip and comfort. The second shape is a teardrop, provided throughout an upper portion of the handle, approximately from the middle of the handle to proximate the end of the handle that connects to the lacrosse head. The handle transitions between the octagonal undulating shape and the teardrop shape, for example, at about the mid-point of the handle, and can then transition again from the teardrop shape to the octagonal shape proximate to the end of the handle for insertion into a socket of the lacrosse head. The cross-sectional shape, length, and location of the octagonal and teardrop portions of the lacrosse stick handle accommodate the gripping, sliding, and carrying techniques unique to lacrosse. For example, the undulating lower portion enhances grip, while the teardrop portion permits hand sliding, which generally occurs at the upper portion of the handle when a player gets ready to pass or shoot.

Another embodiment of the present invention provides a lacrosse stick handle having varying cross-sectional areas (e.g., wall thicknesses) along its length, which can be provided in a handle having a uniform shape and outer dimensions or in a handle having varying cross-sectional shapes and outer dimensions.

In an embodiment of the present invention, the handle is constructed of a metal alloy, for example, formed by casting or hydroforming. The shaped metal handle can be formed as a monolithic part. The metal alloy can be, for example, a zirconium-aluminum alloy, a vanadium-steel alloy, a vanadium-aluminum alloy, a titanium-aluminum alloy, or a scandium-aluminum alloy.

The present invention is described in greater detail in the detailed description of the invention, and the appended drawings Additional features and advantages of the invention will be set forth in the description that follows, will be apparent from the description, or may be learned by practicing the invention.

### DESCRIPTION OF THE DRAWINGS

FIG. 1A is a schematic diagram of a transitioning lacrosse stick handle having octagonal and teardrop portions, according to an embodiment of the present invention.

FIG. 1B is a schematic diagram of a cross-sectional perspective view of a portion of the handle of FIG. 1A over which a transition in cross-sectional shape occurs.

FIG. 1C is a schematic diagram of a perspective view of a portion of the handle of FIG. 1A over which a transition in cross-sectional shape occurs.

FIG. 1D is a schematic diagram of a cross-section of a teardrop portion of the handle of FIG. 1A.

FIG. 1E is a schematic diagram of a cross-section of an octagonal portion of the handle of FIG. 1A.

FIG. 1F is a schematic diagram of side and cross-sectional views of a transitioning lacrosse stick handle having octagonal and teardrop portions, according to a specific implementation of an embodiment of the present invention.

FIG. 1G is a schematic diagram of a representative detailed cross-section of a teardrop portion of the transitioning lacrosse stick handle of FIG. 1F.

FIG. 1H is a schematic diagram of a representative detailed cross-section of an octagonal portion of the transitioning lacrosse stick handle of FIG. 1F.

FIG. 1I is a schematic diagram of another side view of the lacrosse stick handle shown in FIG. 1F, with the handle rotated ninety degrees around its longitudinal axis relative to its position in FIG. 1F.

FIG. 2A is a schematic diagram of a transitioning lacrosse stick handle having octagonal and undulating portions, according to another embodiment of the present invention.

FIG. 2B is a schematic diagram of a portion of the handle of FIG. 2A having an undulating contour to accommodate a player's hand or fingers.

FIG. 2C is a schematic diagram of a cross-sectional perspective view of a portion of the handle of FIG. 2A over which a transition in cross-sectional shape occurs.

FIG. 2D is a schematic diagram of a cross-sectional view of an octagonal portion of the handle of FIG. 2A.

FIG. 2E is a schematic diagram of side and end views of a transitioning lacrosse stick handle having octagonal and undulating portions, according to a specific implementation of an embodiment of the present invention.

FIG. 2F is a schematic diagram of a detailed end view of the octagonal portion of the transitioning lacrosse stick handle of FIG. 2E.

FIG. 2G is a schematic diagram of a detailed end view of the butt end of the transitioning lacrosse stick handle of FIG. 2E.

FIG. 2H is a schematic diagram of a cross-sectional view of the transitioning lacrosse stick handle of FIG. 2E taken along line A-A.

FIG. 2I is a schematic diagram of a cross-sectional view of the transitioning lacrosse stick handle of FIG. 2E taken along line B-B.

FIG. 2J is a schematic diagram of another side view of the lacrosse stick handle shown in FIG. 2E, with the handle rotated ninety degrees around its longitudinal axis relative to its position in FIG. 2E.

FIGS. 3A-3D are schematic diagrams illustrating a method for making a transitioning lacrosse stick handle, according to an embodiment of the present invention.

FIGS. 4A-4E are schematic diagrams illustrating lacrosse handles having variable wall thicknesses, according to an embodiment of the present invention.

### DETAILED DESCRIPTION OF THE INVENTION

An embodiment of the present invention provides a lacrosse stick handle having cross-sections of varying shapes over different portions of the handle. Each shaped portion accommodates a particular hand movement unique to lacrosse stick handling, such as sliding a hand along the length of the handle or gripping a handle to whip the lacrosse stick along its longitudinal axis or to resist torque applied to the lacrosse stick around its longitudinal axis. The cross-sectional shapes are specially located and structured to provide the handle with structural and tactile features that correspond to the way in which a player moves his hands along the handle and grips the handle.

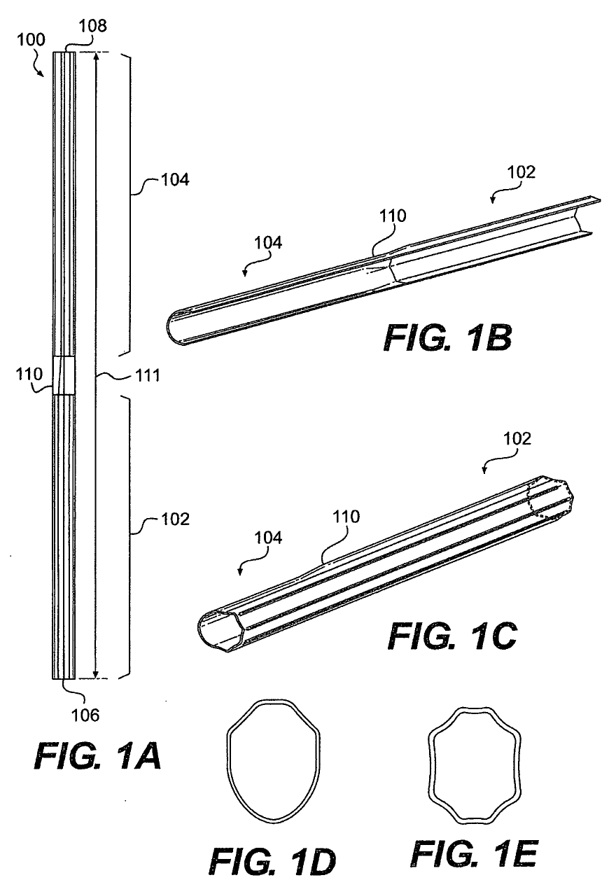

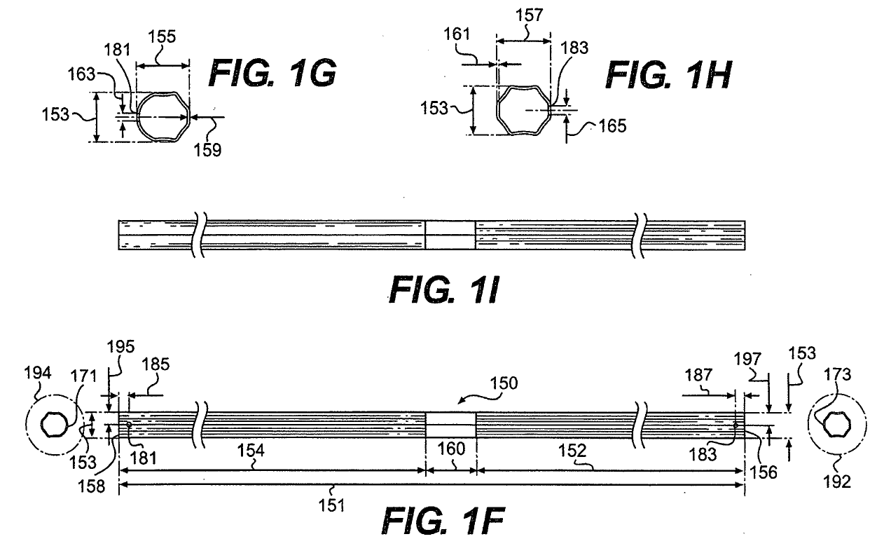

FIGS. 1A-1E illustrate a transitioning lacrosse stick handle 100 according to an embodiment of the present invention, which can attach to a lacrosse head (not shown) to provide a complete lacrosse stick. The typical features of a lacrosse stick are all shown generally in Tucker et al., U.S. Pat. No. 3,507,495 and Tucker et al., U.S. Pat. No. 5,566,947, which are both incorporated by reference herein.

As shown in FIG. 1A, handle 100 includes a lower portion 102 having an extreme concave octagonal cross-section (see FIG. 1E), the lower portion 102 extending from approximately the middle of the handle 100 to the butt end 106 of the handle 100. Handle 100 further includes an upper portion 104 having a teardrop cross-section (see FIG. 1D), the upper portion 104 extending from approximately the middle of the handle 100 to proximate the end 108 of the handle 100 that connects to a lacrosse head. Proximate to end 108, handle 100 can transition to a standard octagonal cross-section (not shown) for insertion into the socket of a lacrosse head that accepts octagonally shaped handles. The length 111 of the handle can be, for example, 32 inches.

FIGS. 1A-1C illustrate the transition portion 110 between the octagonal lower portion 102 and teardrop upper portion 104. As shown, the contours of the handle preferably transform smoothly from one shape to the other. Hydroforming the handle 100 within an appropriately shaped mold can help achieve this smooth transition. In addition, hydroforming can help maintain a constant wall thickness throughout the different shapes. That control over the wall thickness is beneficial in ensuring the strength and rigidity of a handle, and represents a significant advance over traditional manufacturing methods such as extrusion, which cannot easily vary shapes while maintaining a desired wall thickness.

Handle 100 thus provides two different cross-sectional shapes in one lacrosse handle, affording the torque-resisting and grip enhancing properties of the extreme concave octagonal cross-section in the lower portion 102, and the slide-favorable properties of the teardrop cross-section in the upper portion 104.

FIGS. 1F-1I illustrate a specific implementation of a transitioning lacrosse stick handle 150 having octagonal and teardrop portions, according to an embodiment of the present invention. FIG. 1F illustrates side and cross-sectional views of the transitioning lacrosse stick handle 150, with octagonal portion 152, teardrop portion 154, and a transition portion 160 in between the octagonal portion 152 and the teardrop portion 154. The length of octagonal portion 152 can be about 368 mm, for example. The length of teardrop portion 154 can be about 394 mm, for example. The length of transition portion 154 can be about 50.8 mm, for example. The overall length 151 of handle 150 can be about 812.8 mm, for example.

The views 192, 194 show end views or representative cross-sections of the octagonal portion 152 and teardrop portion 154, respectively. In this implementation, the handle 150 has a uniform width 153 of about 22.35 mm, for example. The teardrop portion 154 and octagonal portion 152 are oriented so that the peak 171 of the rounded portion of the teardrop cross-section and the mid-point of a small side 173 of the octagonal cross-section are along the same longitudinal line approximately in the midpoint of the width of the handle, as represented by dimension 195 and 197. With a width 153 of 22.35 mm, dimension 195 and 197 can be approximately 11.17 mm, for example.

FIG. 1G is a schematic diagram of a representative detailed cross-section of a teardrop portion of the transitioning lacrosse stick handle 150 of FIG. 1F. Width 153 can be about 22.35 mm, for example, as mentioned above. Depth 155 can be about 27.05 mm, for example. The wall thickness 159 can be about 1.2 mm, for example. Referring to FIGS. 1F and 1G, a hole 181 can be formed proximate the end 158 of teardrop portion 154, for receiving a fastener to fasten a lacrosse head, butt cap, or other accessory to the handle 150. The distance 185 from the end 158 at which hole 181 is located can be, for example, about 9.35 mm. As shown in FIG. 1F, the hole 181 can be centered along the width 153 at a distance 195 of about 11.17 mm from either end of width 153. The hole 181 can be about 3.2 mm in diameter, for example.

FIG. 1H is a schematic diagram of a representative detailed cross-section of an octagonal portion of the transitioning lacrosse stick handle 150 of FIG. 1F. Width 153 can be about 22.35 mm, for example, as mentioned above. Depth 157 can be about 27.07 mm, for example. The wall thickness 161 can be about 1.2 mm, for example. Referring to FIGS. 1F and 1H, a hole 183 can be formed proximate the distal end 156 of octagonal portion 152, for receiving a fastener to fasten a lacrosse head, butt cap, or other accessory to the handle 150. The distance 187 from the distal end 156 at which hole 183 is located can be, for example, about 9.35 mm. As shown in FIG. 1F, the hole 183 can be centered along the width 153 at a distance 197 of about 11.17 mm from either end of width 153. The hole 183 can be about 3.2 mm in diameter, for example.

FIG. 1I illustrates another side view of the lacrosse stick handle shown in FIG. 1F, with the handle rotated ninety degrees around its longitudinal axis relative to its position in FIG. 1F.

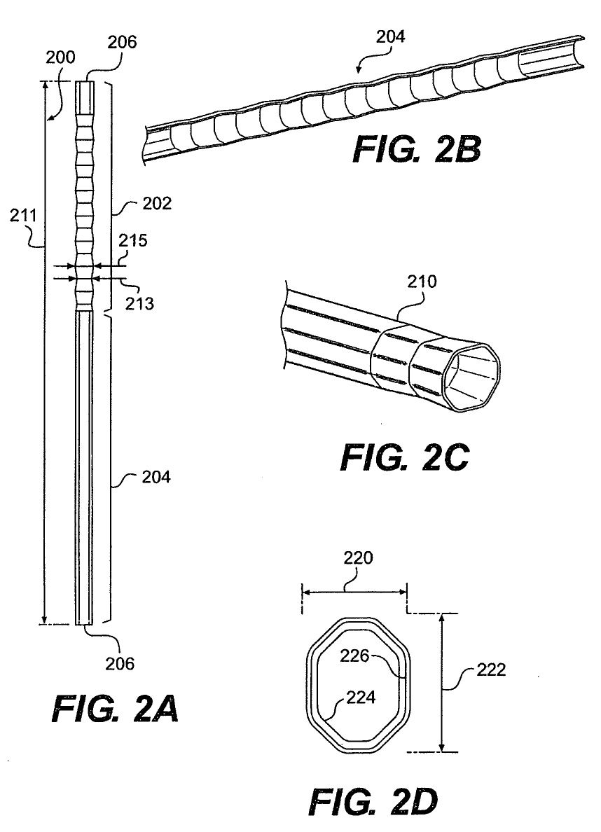

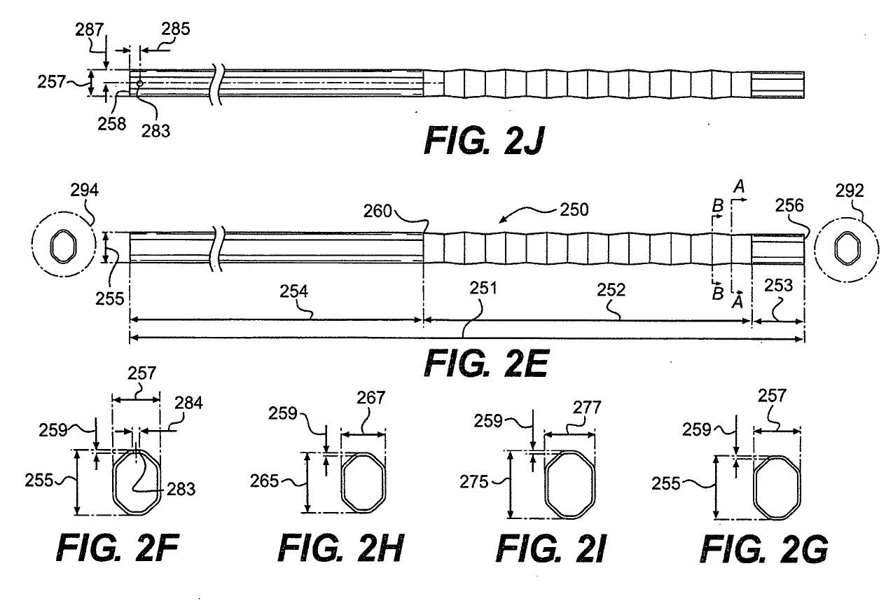

FIGS. 2A-2D illustrate a transitioning lacrosse stick handle 200 according to another embodiment of the present invention, which can attach to a lacrosse head (not shown) to provide a complete lacrosse stick, as with the lacrosse handle 100 of FIGS. 1A-1E.

As shown in FIG. 2A, handle 200 includes a lower portion 202 and an upper portion 204. Lower portion 202 extends from approximately the middle of the handle 200 to the butt end 206 of the handle 100, and has a rounded edge octagonal cross-section (see FIG. 2D) of varying dimensions. As shown in FIGS. 2A and 2B, within the lower portion 202, the outer dimensions of the rounded edge octagon cross-section increase and decrease to provide an undulating contour to the handle, which accommodates a player's hand or fingers. For example, as shown in FIGS. 2A and 2D, the width 220 can vary (e.g., in a sinusoidal wave) between a minimum width 213 of about 1 inch to a maximum width 215 of about 1.12 inches, with the height 222 remaining constant. The cross-sectional view of FIG. 2D illustrates the undulations of lower portion 202 inside handle 200, showing the minimum inside dimensions 224 and maximum inside dimensions 226 of the lower portion 202. At the end of lower portion 202 nearest butt end 206, handle 200 can transition from the undulating contour to an octagonal cross-section to accept a standard butt cap, as shown in FIG. 2A.

Upper portion 204 extends from approximately the middle of the handle 200 to proximate to the end 208 of the handle 200 that connects to a lacrosse head. Upper portion 204 of handle 100 can have a constant outer dimension shaped, for example, as a rounded edge octagonal cross-section or a teardrop cross-section (as in FIG. 1D). In any case, if necessary, proximate to end 208, handle 200 can transition back to an octagonal cross-section for insertion into the socket of a lacrosse head that accepts octagonally shaped handles. The length 211 of the handle can be, for example, 32 inches.

FIG. 2C illustrates the transition 210 between the undulating lower portion 202 and the constant outer dimension upper portion 204. As shown, the contours of the handle preferably transform smoothly from one shape to the other. Hydroforming the handle 200 within an appropriately shaped mold can help achieve this smooth transition.

Handle 200 thus provides two different cross-sectional shapes in one lacrosse handle, affording the torque-resisting and grip enhancing properties of the undulating lower portion 202, and the slide-favorable properties of the constant outer dimension cross-section of the upper portion 204.

FIGS. 2E-2J illustrate a specific implementation of a transitioning lacrosse stick handle 250 having a constant-dimension octagonal portion and an undulating octagonal portion, according to an embodiment of the present invention. FIG. 2E illustrates side and end views of the transitioning lacrosse stick handle 250, with a constant-dimension octagonal portion 254, an undulating octagonal portion 252, a transition portion 260 in between the octagonal portion 254 and the undulating portion 252, and a butt end portion 253 on a side of the undulating portion 252 opposite to the transition portion 260. The length of octagonal portion 254 can be about 459.7 mm, for example. The length of undulating portion 252 can be about 304.8 mm, for example, inclusive of the transition portion 260. The total length 251 of handle 250 can be about 812.8 mm, for example. As shown and explained in more detail below, transition portion 260 transitions from the minimum dimension of the undulating portion 252 (as represented by cross-section A-A in FIGS. 2E and 2H) to the dimensions of the constant-dimension octagonal portion 254. The length of butt end portion 253 can be about 48.3 mm, for example.

The views 292, 294 show end views of the butt end portion 253 and octagonal portion 254, respectively. In this implementation, the octagonal portion 254 and butt end portion 253 have uniform shapes, dimensions, and orientations as shown in the detailed end views of FIGS. 2F and 2G, with, for example, a width 255 of about 27.05 mm, a depth 257 of about 22.35 mm, and a wall thickness 259 of about 1.2 mm.

FIGS. 2H and 2I illustrate cross-sections of the undulating portion 252 of transitioning lacrosse stick handle 250 of FIG. 2E, taken at lines A-A and B-B, respectively. FIG. 2H illustrates a minimum dimension of undulating portion 252, while FIG. 2I illustrates a maximum dimension of undulating portion 252. As shown in FIG. 2H, at the minimum dimension, the width 265 can be, for example, about 25.53 mm and the depth 267 can be, for example, about 20.83 mm. As shown in FIG. 2I, at the maximum dimension, the width 275 can be, for example, about 28.57 mm and the depth 277 can be, for example, about 23.87 mm. The wall thickness throughout the undulating portion 252 can be about 1.2 mm, for example.

FIG. 2J illustrates another side view of the lacrosse stick handle shown in FIG. 2E, with the handle rotated ninety degrees around its longitudinal axis relative to its position in FIG. 2E. Referring to both FIG. 2J and also FIG. 2F, the depth 257 of octagonal portion 254 and butt end portion 253 is, for example, about 22.35 mm. A hole 283 can be formed proximate the distal end 258 of octagonal portion 252, for receiving a fastener to fasten a lacrosse head, butt cap, or other accessory to the handle 250. The distance 285 from distal end 258 at which hole 283 is located can be, for example, about 9.35 mm. The diameter 284 of hole 283 can be about 6.4 mm, for example. As shown in FIG. 2J, the hole 283 can be centered along the depth 257 at a distance 287 of about 11.18 mm from either end of depth 257. Although not shown, another hole similar to the size and placement of hole 283 could be formed proximate to the distal end 256 of the butt end portion 253.

In a further embodiment of the present invention, a butt cap of a handle is formed integrally with the monolithic handle and integrated into the overall shape of the handle. In this manner, the butt end (such as ends 106 and 206 of FIGS. 11A and 2A respectively) is closed and shaped as desired to improve grip on the handle. The shape of the butt end can be molded directly into the end of the handle by, for example, hydroforming. As an example, the butt end can be conically shaped with a diameter or other outer dimension that increases toward the butt end of the handle. The butt end (or any other portion of the handle) can also be formed with texture, such as bumps, nubs, protrusions, grooves, dimpling, knurling, or longitudinal, lateral, or diagonal ridges.

The overall structure of the handle can also vary in outer dimensions or profile to prevent a player's hand from sliding over the end of the overlay and off of the shaft. For example, to improve the gripping of the lacrosse stick at the end opposite to head, the outer dimensions could increase toward the end of the lacrosse stick handle. The resulting substantially conical shape can help prevent the player's hand from slipping off of the end of the handle. The conical shape can also provide the player's hand with more leverage over the shaft, allowing the player to impart increased torque on the lacrosse stick and to achieve better overall control.

In a further embodiment of the present invention, a lacrosse stick handle has cross-sections of varying cross-sectional area along its length. As used herein, cross-sectional area refers to the area of the material of the handle when it is cut in cross-section (and does not include the hollow area in the cross section). This cross-sectional area is related to the wall thickness of the handle. In this embodiment, the cross-sectional area can vary along a handle having a uniform cross-sectional shape (e.g., a uniform outer profile) or can vary along a handle having varying cross-sectional shapes as described above.

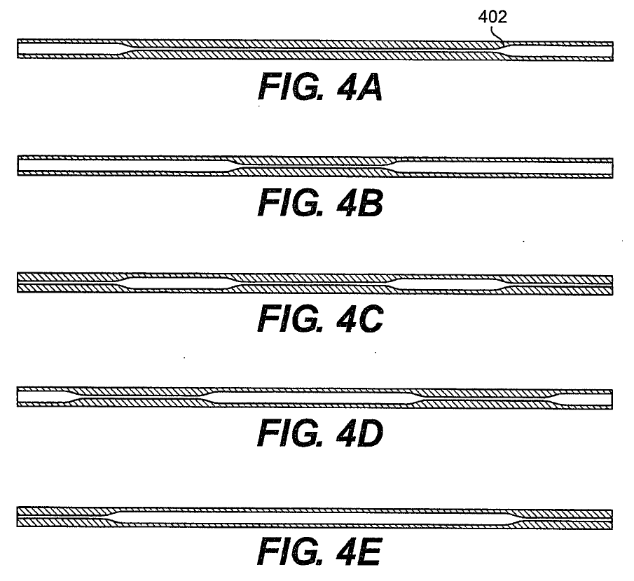

As examples of this embodiment, FIGS. 4A-4E illustrate lacrosse stick handles having variable wall thicknesses and uniform outside dimensions and shapes.

The portions of increased wall thickness can provide strength to desired locations of the handle. As shown, the cross-sectional area can be increased in one location (as in FIGS. 4A and 4B) or in multiple locations (as in FIGS. 4D and 4E showing two locations, or in FIG. 4C showing three locations). The handles can also include transition portions (e.g., at point 402 in FIG. 4A) disposed between the portions of differing cross-sectional area, over which the handle transitions from a first cross-sectional area to a second cross-sectional area.

In addition to varying wall thicknesses, the present invention can also form structures within a hollow handle that improve durability, strength, and resistance to bending and breaking. For example, when viewed in cross-section, one embodiment provides a strut connected to opposing interior walls spans the hollow interior of a handle in a configuration akin to an I-beam. As a further example, when viewed in cross-section, another embodiment provides two struts orthogonal to each other, each connected to opposing interior walls and spanning the hollow interior of the handle in a “T” configuration. As explained in more detail below, hydroforming could be used to manufacture these handles having internal reinforcement structures, by simultaneously injecting pressurized fluid within each of the compartments defined by the internal reinforcement structures.

In an embodiment of the present invention, lacrosse handles having variable cross-sectional shapes, sizes, and/or areas are formed by hydroforming, which is a specialized type of die forming that uses a high pressure hydraulic fluid to press room temperature working material into a die. A hollow tube is placed inside a negative mold that has the shape of the desired lacrosse handle. The tube can be made of a malleable metal, such as a metal alloy (e.g., a zirconium-aluminum alloy, a vanadium-steel alloy, a vanadium-aluminum alloy, a titanium-aluminum alloy, or a scandium-aluminum alloy). The tube can be open ended or closed at one end (e.g., if a butt cap is being integrally formed). A fluid is injected inside the tube under high pressure, which causes the tube to expand against the mold until it matches the shape of the mold. The hydroformed part is then removed from the mold.

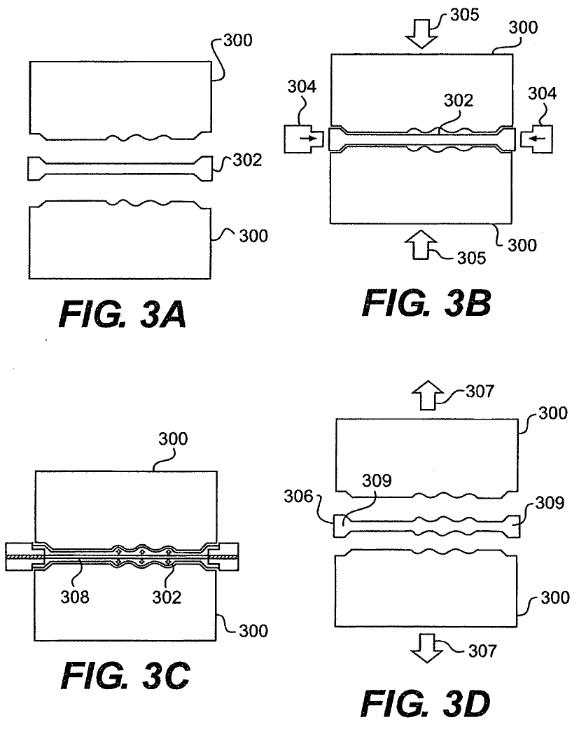

FIGS. 3A-3D illustrate a hydroforming process according to an embodiment of the present invention. As shown in FIG. 3A, a metal tube 302, in this case having two open ends, is placed into an open mold 300 having a top and bottom tool. As shown in FIG. 3B, the top and bottom tool then close onto the metal tube 302 as represented by the arrows 305, with the two open ends of the metal tube 302 exposed at the sides of top and bottom tool. Two side high pressure water jets 304 are then inserted into the two open ends of the metal tube 302 until they completely seal the open ends. As shown in FIG. 3C, at room temperature, high pressure water 308 is pushed into the metal tube 302 through the open ends, which pushes the walls of the tube 302 outward and against the inside walls of the top and bottom tool. Then, as shown in FIG. 3D, the top and bottom tool open (as represented by the arrows 307) to expose the hydroformed metal tube 306. The ends of hydroformed metal tube 306 can be cut square, ground, or otherwise finished to provide a final handle suitable for play. In one embodiment, in which the ends of tube 302 are expanded in diameter to accommodate the connections to the high pressure water jets 304, the expanded portions 309 of the hydroformed metal tube 306 are cut off.

In an embodiment of the invention, the cycle time for the hydrodynamic manufacturing process shown in FIGS. 3A-3D is one to five minutes per part, depending on manufacturing parameters such as shape and wall thickness.

In addition to hydroforming, further embodiments of the present invention form the handle using any of the following methods or combinations thereof: casting metal in a mold, sand casting, injection molding, machining, and swedging (e.g., forcing an object through a smaller opening to shape it).

Although FIGS. 1D, 1E, 1F, 1G, 1H, 2D, 2E, 2F, 2H, 2I, and 2G depict particular cross-sections or open ends, the invention is not limited to the particular depicted shapes, dimensions, areas, or proportions. Indeed, the present invention could incorporate other shapes such as circles or ovals, as well as other outer dimensions, inner dimensions, and wall thicknesses. Therefore, notwithstanding the particular benefits associated with the shapes, dimensions, areas, and proportions shown and described herein, the present invention should be considered broadly applicable to any lacrosse handle having varying cross-sections.

In addition, although embodiments shown in the figures include two cross-sectional shapes, the invention encompasses a lacrosse stick handle having any number of cross-sectional shapes, including three or more. For example, an embodiment of the present invention could have three different cross-sectional shapes, such as octagonal, undulating, and teardrop, with transition portions between each of the differently shaped portions. The invention is therefore not limited to any particular number of different cross-sectional shapes, sizes, or areas.

Overall, embodiments of the present invention providing a handle with multiple cross-sectional shapes, sizes, and areas afford significant, unexpected benefits to a lacrosse stick. The shapes (e.g., the teardrop shape) can provide hand registration on the handle, which can prompt a player for optimal hand placement on the handle and enable the player to feel the orientation of the lacrosse stick (i.e., which way the ball receiving side of the lacrosse head is facing) without looking at the lacrosse stick. The changes in shape can also add strength to a handle, for example, transitioning from a traditional teardrop shape to an octagonal shape to add strength. The changes in cross-sectional area can likewise add strength to a handle where desired. The invention can also incorporate unique shapes that are aesthetically pleasing and structurally sound, with multiple profiles and cross sections, and seamless transitions between the different shapes. The cross-sectional shapes can also incorporate shapes that accommodate palm and finger placement, for example, providing bumps, undulations, or indents strategically located to improve throw and shooting accuracy and the overall balance and stability of the stick. The specially shaped handle can also increase the surface area of the handle to improve a player's grip on the handle, without adding undesirable weight to the entire lacrosse stick.

A further aspect of the present invention provides varying cross-sectional shapes, sizes, and areas at the ends of a lacrosse handle. For example, as described above, a butt end or cap can be integrally formed at an end of a handle. As another example, the end of a handle can be specially formed to accommodate connections to a lacrosse head or to other accessories, such as a separate butt cap. In one implementation, an end of a handle changes in shape and dimension to match the shape and dimension of the receiving connection (e.g., socket) on a lacrosse head.

For example, women's handles that are ⅞ inches wide can be enlarged at one end to increase the width to 1 inch, which is a typical size of a socket in a lacrosse head. The specially formed end would therefore obviate the need for adapters, which are commonly used in conventional configurations to attach a ⅞-inch women's handle to a standard 1-inch socket of a lacrosse head.

Other types of connections could also be specially formed in the end of a handle. For example, mechanical fittings such as threads could be formed at the end of handle such that the handle could be screwed into a lacrosse head having a correspondingly tapped socket. As another example, the end of a handle could be formed to provide a compression fit or interference fit with a corresponding fitting on a lacrosse head.

In addition to differing cross-sectional shapes, sizes, and areas, other embodiments of the present invention can provide lacrosse stick handles that change in direction, rather than defining a single longitudinal axis. For example, portions of a handle can be canted or curved with respect to other portions of the handle. In one implementation, a handle has a main portion and a dowel portion. The main portion of the handle defines a main longitudinal axis. The dowel portion is a short portion of at one end of the handle. The dowel portion defines a dowel portion axis that is at an angle to the main longitudinal axis, such that the dowel portion is canted with respected to the main portion. A lacrosse head connected to the dowel portion of the handle can provide an offset lacrosse stick. Hydroforming the handle within an appropriately shaped mold can achieve this canted configuration. In addition to linear angular canting, other embodiments can form curves or combinations of curves and linear angular cants.

A further aspect of the present invention enhances grip on a transitioning lacrosse head as described above, by applying a coating having a coefficient of friction higher than the material from which the handle is formed. For example, a rubberized grip coating can be provided on a metal handle. The rubberized grip coating can be applied in a secondary manufacturing process in which, for example, the coating is sprayed onto the handle and heated.

The embodiments of the present invention described above apply equally well to men's lacrosse sticks, to women's lacrosse sticks, to sticks for players of all sizes and ages, to sticks used in competition lacrosse (e.g., professional, club, and box lacrosse, and lacrosse governed in whole or in part by NCAA or U.S. Women's Lacrosse Association rules), and to sticks used in non-competition lacrosse (e.g., recreational and instructional lacrosse sticks used in physical education classes). In each application, the present invention is adaptable to provide unique advantages for different types of players. For example, for men's lacrosse sticks, the present invention can provide undulating octagonal portions of a larger width to accommodate larger hands and provide improved grip and feel.

Other embodiments of the invention will be apparent to those skilled in the art from consideration of the specification and practice of the invention disclosed herein. It is intended that the specification and examples be considered as exemplary only, with a true scope and spirit of the invention being indicated by the claims. In addition, as one of ordinary skill in the art would appreciate, any dimensions shown in the drawings or described in the specification are merely exemplary, and can vary depending on the desired application of the invention.

The foregoing disclosure of embodiments of the present invention has been presented for purposes of illustration and description. It is not intended to be exhaustive or to limit the invention to the precise forms disclosed. Many variations and modifications of the embodiments described herein will be obvious to one of ordinary skill in the art in light of the above disclosure. The scope of the invention is to be defined only by the claims, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. An integrally formed monolithic lacrosse stick handle comprising:
a first portion having a first cross-section of a first shape;
a second portion having a second cross-section of a second shape, wherein the second shape is different from the first shape; and
a transition portion disposed between the first portion and the second portion, over which the handle transitions from the first shape to the second shape,
wherein the handle is integrally formed from a malleable material.

2. The lacrosse stick handle of claim 1, wherein the handle is hollow.

3. The lacrosse stick handle of claim 2, wherein the first shape includes a strut disposed within the hollow handle and connecting opposing interior walls of the handle.

4. The lacrosse stick handle of claim 1, wherein the malleable material is a metal alloy.

5. The lacrosse stick handle of claim 1, wherein the malleable material is one of a zirconium-aluminum alloy, a vanadium-steel alloy, a vanadium-aluminum alloy, a titanium-aluminum alloy, and a scandium-aluminum alloy.

6. The lacrosse stick handle of claim 1, further comprising an integrally formed closed end.

7. The lacrosse stick handle of claim 6, wherein the closed end comprises a butt cap.

8. The lacrosse stick handle of claim 1, further comprising:
a third portion having a third cross-section having a cross-sectional shape different from the second shape; and
a second transition portion disposed between the second portion and the third portion, over which the handle transitions from the second shape to the cross-sectional shape of the third cross-section.

9. The lacrosse stick handle of claim 1, wherein the first cross-section defines a first wall thickness and the second cross-section defines a second wall thickness different from the first wall thickness.

10. The lacrosse stick handle of claim 1, wherein the first shape comprises a concave octagonal shape and the second shape comprises a teardrop shape.

11. The lacrosse stick handle of claim 1, wherein the first shape comprises a constant-dimension octagonal shape and the second shape comprises an undulating octagonal shape.

12. The lacrosse stick handle of claim 1, wherein the lacrosse stick handle has a substantially constant wall thickness throughout the first portion, the second portion, and the transition portion.

13. The lacrosse stick handle of claim 1, wherein the second portion and the transition portion are coaxial and define a longitudinal axis,
wherein the first portion comprises
a straight portion connected to the transition portion and defining an axis aligned with the longitudinal axis and
a canted portion connected to the straight portion opposite to the transition portion and defining an axis at an angle to the longitudinal axis, wherein a distal end of
the first portion opposite to the straight portion is configured to connect to a lacrosse head.

14. The lacrosse stick handle of claim 1, further comprising a lacrosse head connected to one of the first portion and the second portion.

15. The lacrosse stick handle of claim 1, wherein a mechanical fitting is integrally formed in a distal end of the second portion to connect to a complementary mechanical fitting of a lacrosse head.

16. A method for forming an integrally formed monolithic lacrosse stick handle comprising:
inserting a hollow tube made of malleable material into a cavity of a negative mold, the negative mold defining at least two different outer cross-sectional shapes along the length of the cavity;
injecting a fluid into the hollow tube under pressure such that the hollow tube expands and is pressed against the negative mold;
releasing the pressurized fluid when the hollow tube matches the shape of the cavity, thereby forming the hollow tube into a lacrosse stick handle having
a first portion having a first cross-section of a first shape;
a second portion having a second cross-section of a second shape, wherein the second shape is different from the first shape; and
a transition portion disposed between the first portion and the second portion, over which the handle transitions from the first shape to the second shape; and
removing the lacrosse stick handle from the negative mold.

17. The method of claim 16, the malleable material comprising a metal alloy.

18. The method of claim 16, wherein the hollow tube has a closed end such that the closed end is pressed against the negative mold to form a butt cap.

19. The method of claim 16, the lacrosse stick handle further having:
a third portion having a cross-sectional shape different from the second shape; and
a second transition portion disposed between the second portion and the third portion, over which the handle transitions from the second shape to the cross-sectional shape of the third cross-section.

20. The method of claim 16, wherein the first cross-section defines a first wall thickness and the second cross-section defines a second wall thickness different from the first wall thickness.

21. The method of claim 16, wherein the hollow tube includes an interior strut continuously connected to opposing interior walls of the tube for the length of the hollow tube, wherein the interior strut defines a plurality of compartments within the tube, and wherein injecting the fluid into the hollow tube comprises injecting the fluid simultaneously into each of the plurality of compartments.

22. The method of claim 16, wherein the first shape comprises a concave octagonal shape and the second shape comprises a teardrop shape.

23. The method of claim 16, wherein the first shape comprises a constant-dimension octagonal shape and the second shape comprises an undulating octagonal shape.

24. The method of claim 16, wherein the lacrosse stick handle has a substantially constant wall thickness throughout the first portion, the second portion, and the transition portion.

25. The method of claim 16, further comprising forming a mechanical fitting in a distal end of the second portion, wherein the mechanical fitting is configured to connect to a complementary mechanical fitting on a lacrosse head.

26. The method of claim 25, wherein the mechanical fitting comprises threads.

27. An integrally formed monolithic lacrosse stick handle comprising:
a first portion having a first cross-section of a first cross-sectional area;
a second portion having a second cross-section of a second cross-sectional area, wherein the second cross-sectional area is different from the first cross-sectional area; and
a transition portion disposed between the first portion and the second portion, over which the handle transitions from the first cross-sectional area to the second cross-sectional area,
wherein the handle is integrally formed from a malleable material.

28. The lacrosse stick handle of claim 27, wherein the handle has a uniform outer profile for any cross-section taken along the handle.

29. The lacrosse stick handle of claim 27, wherein the handle has a uniform wall thickness for any cross-section taken along the handle.

30. The lacrosse stick handle of claim 27, wherein the first cross-section has a first constant wall thickness and the second cross-section has a second constant wall thickness, wherein the second constant wall thickness is greater than the first constant wall thickness, and wherein a wall thickness in the transition portion increases from the first constant wall thickness to the second constant wall thickness.
